(19) United States
(12) Patent Application Publication
(10) Pub. No.: US 2026/0105283 A1
(43) Pub. Date: Apr. 16, 2026

(54) EARLY AUTOMATED DETECTION OF SYSTEM CHANGE CAUSED ISSUES

(71) Applicant: Citibank, N.A., New York, NY (US)

(72) Inventor: Ramesh Kumar Vasudeva KUMAR, Rutherford, NJ (US)

(73) Assignee: Citibank, N.A., New York, NY (US)

(21) Appl. No.: 18/915,192

(22) Filed: Oct. 14, 2024

(51) Int. Cl. G06N 3/0455; G06F 11/07; G06N 3/0475; G06N 3/096

(52) U.S. Cl. CPC G06N 3/0455; G06F 11/0709; G06F 11/076; G06F 11/0784; G06N 3/0475; G06N 3/096

(57) ABSTRACT

Systems and methods disclosed comprising instructions to access search criteria of a service update report for a runtime service of computing system, receive a user feedback report indicating erroneous features within the runtime service, generate a first embedding vector for text content of the user feedback report, determine a first similarity score between the first embedding vector and a reference embedding vector, identify similar content between a set of descriptors and text contents of the user feedback report, determine a text segment from the text contents corresponding to the identified similar content, generate a second embedding vector for the determined text segment, determine a second similarity score between the second embedding vector and the reference embedding vector, increment an incidence frequency score for the runtime service, and send a notification message to subscribed users recommending maintenance review of the runtime service when the incidence frequency score exceeds a tolerance threshold.

### BACKGROUND

Natural language processing (NLP) is an interdisciplinary subfield of computer science and artificial intelligence. It is primarily concerned with providing computers with the ability to process data encoded in natural language and is thus closely related to information retrieval, knowledge representation and computational linguistics, a subfield of linguistics. Data is frequently collected in text corpora, using either rule-based, statistical, or neural-based approaches in machine learning and deep learning. Major tasks in natural language processing are speech recognition, text classification, natural-language understanding, and natural-language generation.

A large language model (LLM) is a language model notable for its ability to achieve general-purpose language understanding and generation. LLMs acquire these abilities by learning statistical relationships from text documents during a computationally intensive self-supervised and semi-supervised training process. LLMs can be used for text generation, a form of generative artificial intelligence (GenAI), by taking an input text and repeatedly predicting the next token or word.

Generative artificial intelligence (AI) is a machine learning paradigm capable of generating text, images, videos, or other data using generative models, often in response to prompts. Generative AI models learn the patterns and structure of their input training data and then generate new data that has similar characteristics.

### BRIEF DESCRIPTION OF THE DRAWINGS

Detailed descriptions of implementations of the present invention will be described and explained through the use of the accompanying drawings.

FIG. 1 is a block diagram showing an illustration of an incidence detection system that can implement aspects of the present technology.

FIG. 2 is a block diagram illustrating functioning of the incidence detection system, in accordance with some implementations of the present technology.

FIG. 3 is a block diagram illustrating example components of an incidence detection interface of an incidence detection system, in accordance with some implementations of the present technology.

FIG. 4 is a flow diagram that illustrates a process to generate service maintenance recommendations in some implementations.

FIG. 5 is a block diagram that illustrates example components incorporated in at least some of the computer systems and other devices on which the disclosed system operates.

FIG. 6 is a system diagram illustrating an example of a computing environment in which the disclosed system operates in some implementations.

FIG. 7 is an illustrative diagram illustrating a machine learning model, in accordance with some implementations of the present technology.

FIG. 8 is a block diagram of an example transformer that can implement aspects of the present technology.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Existing systems often require manual identification of erroneous service features introduced following a system update. Subtle service errors, such as low-priority issues, often remain undetected by human monitors until a substantial number of user feedback (e.g., customer complaint reports) has been received. By the time these issues are manually identified, a significant amount of time may have passed, allowing the erroneous service feature to potentially impact numerous users and dependent downstream services. To further compound this issue, unnoticed problems within a runtime service can accumulate across several service updates, which further complicates remediation strategies and extends the time required to deploy proper solutions. As a result, these and other problems of inefficient manual detection of erroneous service features can significantly diminish the overall user experience, place undue burden on maintenance support teams, negatively impact service providers and dependent systems, financial stability for consumers, restitutions for customers from service providers, resolutions for regulatory non-compliance and remediation efforts, and so forth.

To overcome these and other disadvantages of existing systems, this application discloses systems and related methods for early detection of erroneous features of a runtime service introduced by an update (e.g., new firmware release, software update/release, changes in system configuration (hardware and/or software), and the like)) to a computing system. The disclosed system can dynamically analyze content similarities between incoming user feedback (e.g., consumer complaint reports) and descriptors of the system update (e.g., change release notes) by leveraging natural language processing methods and generative machine learning technologies. In response to identifying a high frequency of erroneous features associated with a specific system update, the disclosed method can submit a notification to subscribed users (e.g., system maintenance teams) indicating recommended review of the afflicted runtime service.

The system can identify content similarities between user feedback data and descriptors of a system update based on semantic embeddings. As an example, the disclosed system can use semantic encoders to generate unique embeddings for both text content of the user feedback data and descriptors of the system update. By comparing the generated embeddings, the disclosed system can determine a similarity score of the user feedback contents with respect to the system update. In response to the determined similarity score exceeding specified thresholds, the disclosed system can incrementally increase an incidence frequency score of a runtime service corresponding to the system update. Accordingly, the disclosed system can respond to high incidence frequency scores (e.g., exceeding a tolerance threshold) by submitting a notification to subscribed users that recommends further review of the runtime service features.

In some aspects, the disclosed system can use generative machine learning models to determine content within user feedback data that is similar to descriptors of the system update. For example, the disclosed system can prompt a generative machine learning model to create a response identifying specific portions of text content (e.g., keywords, phrases, etc.) from the user feedback that are relevant to the descriptors of the system update.

Several advantages of the disclosed system include automatic processing and early detection of potential erroneous service features, dynamic evaluation of user feedback reports, and robust identification of similar content between user feedback and system update information. For illustrative purposes, examples are described herein in the context of identifying erroneous service features with respect to computing system updates. However, a person skilled in the art will appreciate that the disclosed system can be applied in other contexts. As an example, the disclosed methods can be utilized by vulnerability detection services, enabling early detection of potential security issues within computing systems before such issues develop into significant problems.

Attempting to create the disclosed system for automatic identification of erroneous runtime service features in view of the available conventional approaches created significant technological uncertainty for the inventors. Creating such systems required addressing several unknowns in conventional approaches in mapping user reported errors to appropriate runtime service features, such as identifying a relevant service update, or a version of the runtime service. Similarly, conventional approaches of correlating user reported errors to appropriate runtime service features did not provide methods of determining content similarities between user reported errors and service update notes, such as change service records.

Conventional approaches rely on manual evaluation of user reported errors and identification of corresponding runtime services, which often requires a significant time and resource investment for assessing each individual user report. Due to practical limitations of human evaluation methods, conventional approaches are often unable to adequately cover each and every user reported error or problematic service feature. For example, a conventional system may, and fail to fully review all user reports submitted within a given day, or other time interval. To address this, conventional approaches typically involve heuristic optimizations that direct attention of human evaluators to the most significant and critical service issues, which often results in long, or indefinite, delays for resolving minor or obscure issues. Conversely, the disclosed system introduces an automated incidence detection system that overcomes the physical limitations and weaknesses of manual human evaluators.

To overcome the technological uncertainties, the inventors systematically evaluated multiple design alternatives. For example, the inventors tested various machine learning algorithms, such as generative machine learning models, to determine which would be most effective for identifying content similarities within a text-based corpus. The inventors further experimented with dynamic thresholding techniques to provide an enhanced internal validation of machine learning generated results, which allowed the inventors to efficiently automate the process identifying relevant service change notes associated with user reported issues and/or errors.

The direct use of output results from generative machine learning models proved to be inconsistent as it failed to adequately identify similar content between, and within, user reported information and service change notes. Furthermore, this approach lacked a standardized quantifiable metric for evaluating content similarity. Similarly, using simple thresholding methods, such as a single broad content similarity threshold, failed to effectively filter mappings of user reported errors to non-relevant service change notes.

Thus, the inventors experimented with different methods for iterative identification and filtering of similar content between user submitted information and service change notes associated with a runtime service. For example, the inventors introduced the use of semantic embedding vectors to enable quantifiable comparisons of similarity (e.g., cosine similarity, Euclidean distance, and/or the like) between user reports and service change notes. Additionally, the inventors systematically evaluated different strategies for identifying significant incidents associated with runtime services. The inventors evaluated, for example, different methods of thresholding incident frequency data for a runtime service, such as by using a dynamic tolerance value that adapts to the relative count of user reported errors for a specific service.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### System Overview

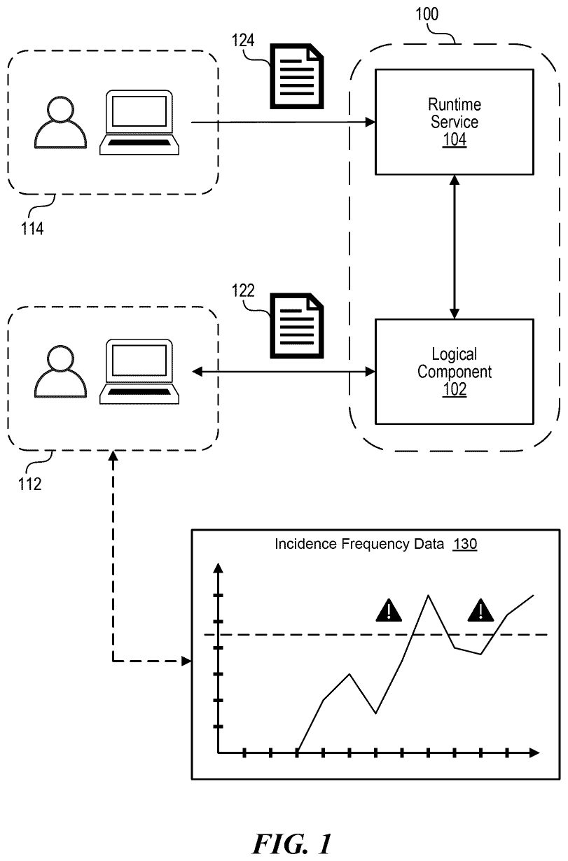

FIG. 1 is a block diagram showing an illustration of an incidence detection system 100 (“system 100”) that can implement aspects of the present technology. The system 100 can comprise a logical component 102 that is configured to generate incidence frequency data 130 (e.g., severity of erroneous features) of a runtime service 104 (e.g., a remote hosted application). The system 100 can communicatively couple the logical component 102 to interfacing user devices of an authorized user 112 (e.g., a verified maintenance staff) and/or an end-service user 114 (e.g., an application consumer, a service developer, a feature tester, and/or the like) for the runtime service 104.

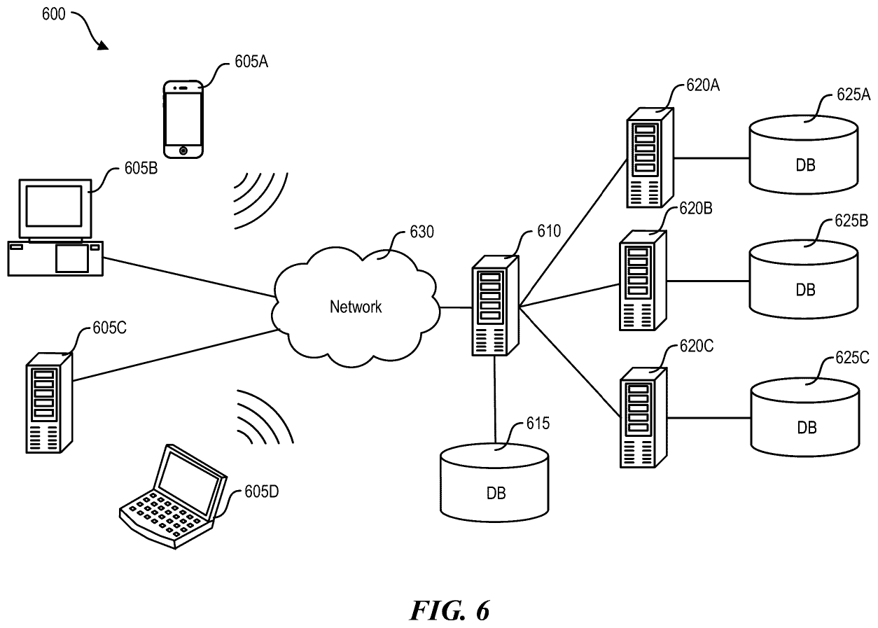

The system 100 can configure the logical component 102 to enable an authorized user 112 to transmit service update reports 122 (e.g., a service change record) detailing modifications to an existing version of the runtime service 104. In some implementations, the logical component 102 can be configured to receive the service update reports 122 synchronously with propagation of service updates to the runtime service 104. The system 100 can further configure the logical component 102 to enable end-service users 114 to submit user feedback reports 124 (e.g., customer complaint reports and/or forms) indicating presence of erroneous features (e.g., missing variables, false notifications, incorrect information, and/or the like) in one or more aspects of the runtime service 104. The system 100 can communicatively couple (e.g., via an API service) the logical component 102 to a remote computing database (e.g., similar to example databases 615 and 625 of FIG. 6) for accessing and/or storing user submitted data structures. For example, the system 100 can configure the logical component 102 to read and/or write data corresponding to a service update report 122 or a user feedback report 124 at the remote computing database.

In some implementations, the logical component 102 can be configured to actively monitor (e.g., in real-time) and detect erroneous service features of the runtime service 104 via analysis of content (e.g., text descriptions) similarities between service update reports 122 and user feedback reports 124. For example, the logical component 102 can compare contents (e.g., error feature characteristics, details of afflicted service features, and/or the like) of user feedback reports 124 to contents (e.g., target service features, possible consumer impacts, and/or the like) of service update reports 122 to identify potential correspondences between end-service user 114 identified service errors and authorized user 112 submitted service updates.

In response to determining a correlation/relationship (e.g., computed using high cosine similarity scores, Euclidean distances, and/or the like) between a select user feedback report 124 and a service update report 122, the logical component 102 can incrementally increase an incidence frequency score (e.g., relative presence and/or magnitude of client-side impacts from erroneous service features) associated with the runtime service 104. In some implementations, the logical component 102 can append an incidence datapoint (e.g., additional frequency count at a specified time) to update the incidence frequency data 130 associated with the runtime service 104. Logical component 102 can be one or more of: a data model, a machine learning model, a computer program, or other logical components configured for receiving, transmitting, analyzing user submitted data (e.g., feedback data, service updates)—and/or processing—related data.

### Incidence Detection System

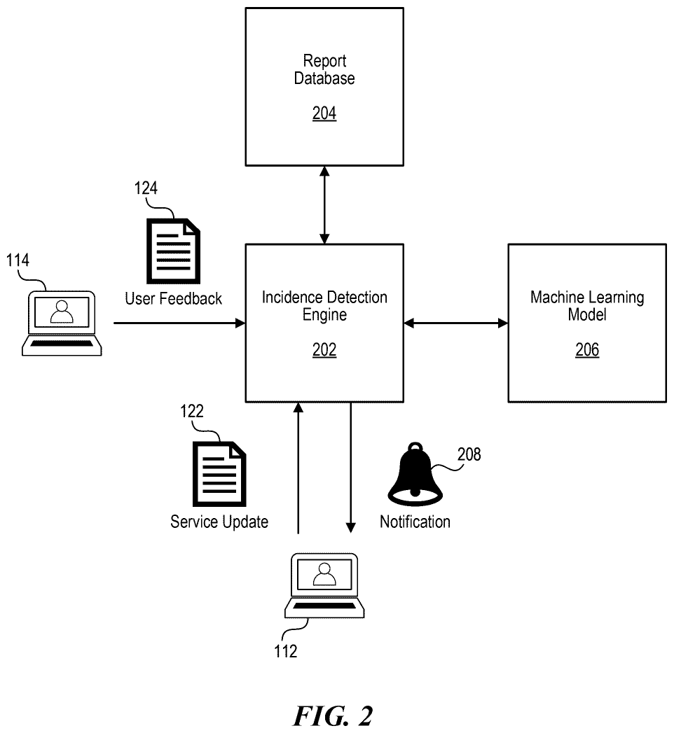

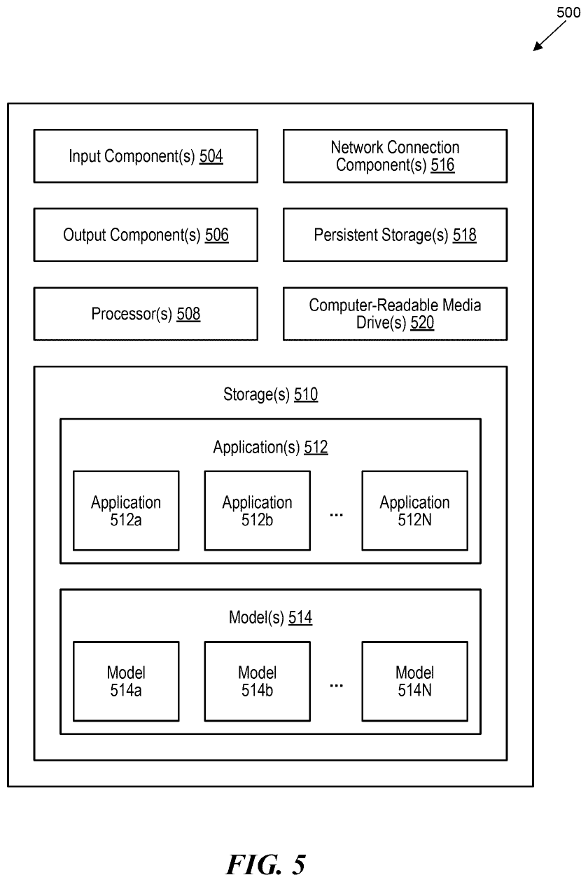

FIG. 2 is a block diagram illustrating functioning of the incidence detection system, in accordance with some implementations of the present technology. The illustrated interactions can be performed via incidence detection engine 202 (“engine 202”) configured to execute one or more operations involving an authorized user 112, an end-service user 114, a service update report 122, a user feedback report 124, a report database 204, a machine learning model 206, and a notification message 208. Incidence detection engine 202 and machine learning model 206 are implemented using components of example devices 500 and computing devices 620 illustrated and described in more detail with reference to FIG. 5 and FIG. 6, respectively. Likewise, implementations of example interactions can include different and/or additional components or can be connected in different ways.

The incidence detection engine 202 can be configured to obtain service update reports 122, such as a change service record, for a runtime service. For example, the engine 202 receives a service update report 122 from an authorized user 112 (e.g., a service developer, a verified maintenance staff, and/or the like) via a user interface device that is communicatively coupled to the engine 202. In some implementations, the engine 202 receives the service update report 122 from the authorized user 112 as a component step (e.g., a subprocess) in deployment of a service update to the runtime service (e.g., a new software version for service). The engine 202 can store the service update reports 122 at a dedicated report database 204.

The service update report 122 can comprise one or more searchable characteristics, or search criterions, that enables the engine 202 to map, and uniquely identify, service update reports 122 associated with the runtime service. As an illustrative example, the service update report 122 includes a set of descriptive features, or descriptors, that detail variations and/or adjustments applied to the runtime service via deployment of the service update. The set of descriptive features can include a keyword (e.g., code phrases, feature-specific terminology), a text phrase, a detailed service change record, and/or additional documentation of the service update submitted by the authorized user 112.

The service update report 122 can further comprise an embedding vector (e.g., pre-encoded via a semantic encoder) representing a quantitative representation of the one or more searchable characteristics. In some implementations, the engine 202 can be configured to generate the embedding vector using the one or more searchable characteristics of the service update report 122. For example, the engine 202 can use a semantic encoding function (e.g., a natural language processing model) to convert the searchable characteristics into a semantic embedding vector. In additional or alternative implementations, the service update report 122 includes a set of similarity thresholds for the embedding vector of the searchable characteristics. In other implementations, the engine 202 can access (e.g., from the report database 204) a predetermined set of similarity thresholds that are applicable to a specified set of service update reports 122. Accordingly, the engine 202 can use the similarity thresholds to assess relative correlation between semantic embedding vectors and the reference embedding vector. For example, the engine 202 can apply a cosine similarity evaluation, or other quantitative comparison functions (e.g., machine learning models, natural language processing methods, and/or the like), to determine a similarity score. The engine 202 can compare the similarity score to the similarity thresholds to determine whether a semantic embedding vector is sufficiently correlated to the reference embedding vector. In other implementations, a similarity threshold of the reference embedding vector can be configured as a static (e.g., non-mutable) or a dynamic (e.g., mutable) threshold.

The incidence detection engine 202 can be further configured to receive user feedback reports 124, such as an end-user complaint form, for a runtime service. For example, the engine 202 can receive a user feedback report 124 from an end-service user 114 via a user interface device that is communicatively coupled to the engine 202. The engine 202 can store the user feedback report 124 at a dedicated report database 204.

The user feedback report 124 can comprise descriptive characteristics representative of one or more erroneous features associated with the runtime service. For example, the user feedback report 124 includes a set of text content (e.g., form-based text input data, user submitted messages, and/or the like) corresponding to contextual information (e.g., a missing service function, an incorrect variable, a timestamp of identified incident, and/or the like) that detail the specific nature of identified erroneous service features of the runtime service. Alternatively/additionally, the user feedback report 124 comprises audio signal data (e.g., a recorded testimony/customer compliant record) that describes/discusses the erroneous service features. Accordingly, the engine 202 can use audio analysis functions (e.g., a speech-to-text algorithm, a machine learning model, a natural language processing method, and/or the like) to convert the audio signal data into a text-based transcript.

The user feedback report 124 can further comprise a set of recorded user interactions (e.g., of the end-service user 114) with the runtime service via an interactable user device. For example, the set of recorded user interactions includes a selection (e.g., or avoidance) of specific service features, interface navigation patterns (e.g., service exploration routes), and/or identifiable behavioral changes with respect to a prior set of user interactions at the runtime service. In some implementations, the recorded user interactions can comprise a mapping to a reference service feature that correlates to one or more behavioral characteristics of the end-service user 114. In other implementations, the engine 202 can be configured to generate the mapping between reference service features and end-service user 114 behavioral characteristics for the recorded user interactions. For example, the engine 202 can invoke a machine learning algorithm (e.g., a generative machine learning model) to determine approximate correlation measure between contents of a service update report 122 and descriptive behavioral characteristics of the end-service user 114. In response to the approximated correlation measure exceeding a mapping threshold, the engine 202 can link the recorded user interactions of the behavioral characteristics to the runtime service associated with the service update report 122. In additional or alternative implementations, the engine 202 can be configured to passively retrieve (e.g., a background process) recorded user interactions from the interactable user device without requiring direct submission from the end-service user 114.

The incidence detection engine 202 can be further configured to identify relevant runtime services and/or features associated with erroneous features described within a user feedback report 124. For example, the engine 202 can receive a user feedback report 124 from an end-service user 114 indicating presence of erroneous features within a runtime service. In response, the engine 202 can access, from the report database 204, a set of service update reports 122 to initiate a search for relevant runtime services and/or features. As an illustrative example, the engine 202 can determine the set of descriptors, the set of similarity thresholds, and/or the reference embedding vector for each service update report 122.

The engine 202 can use text contents of a user feedback report 124 to generate a corresponding semantic embedding vector via a semantic encoding function (e.g., a natural language processing method, a machine learning model, and/or the like). By comparing the semantic embedding vector and the reference embedding vector (e.g., via cosine similarity, statistical inference algorithms, and/or the like), the engine 202 can determine a content similarity score between the user feedback report 124 and the service update report 122. The engine 202 can further compare the determined content similarity score with a select similarity threshold of the select service update report 122 to evaluate a correlation strength between the user feedback report 124 and the service update report 122.

In some implementations, the engine 202 can evaluate content similarities of a user feedback report 124 to other user feedback reports 124 (e.g., prior submitted user feedback reports, new user feedback reports, and/or the like). For example, the engine 202 can use text contents of a first user feedback report 124 to generate a first semantic embedding vector via a semantic encoding function. Further, the engine 202 can use text contents of a second user feedback report 124 to generate a second semantic embedding vector via the semantic encoding function. By comparing the first and the second semantic embedding vectors (e.g., via cosine similarity, statistical inference algorithms, and/or the like), the engine 202 can determine a content similarity score between the first and the second user feedback reports 124. The engine 202 can further compare the determined content similarity score with a report similarity threshold to evaluate a correlation strength between contents of the first and the second user feedback reports 124.

In response to the content similarity score for the first and the second user feedback reports 124 satisfying the report similarity threshold value (e.g., a range of threshold values), the engine 202 can assign both the first and the second user feedback reports 124 (e.g., via assigning the first and the second embedding vectors) to a relational report group. A relational report group represents a set, or cluster, of user feedback reports that share similar content information (e.g., high content similarity scores). The engine 202 can further use the semantic embedding vectors corresponding to member user feedback reports 124 of a relational report group to generate a group embedding vector for the relational report group via a semantic encoding function. In some implementations, the engine 202 can use machine learning models 206 (e.g., unsupervised clustering algorithms, statistical inference methods, and/or the like) to dynamically determine the report similarity thresholds for assigning user feedback reports 124 to the relational report groups. In additional or alternative implementations, the engine 202 can be configured to generate a group embedding vector for the relational report group in response to a total number of member user feedback reports 124 (e.g., reports assigned to the relational report group) exceeding an incidence tolerance threshold (e.g., a range of threshold values).

In further implementations, the engine 202 can map a relational report group of user feedback reports 124 to individual service update reports 122. For example, the engine 202 can compare the group embedding vector of the relational report group to the reference embedding vector of a service update report 122 (e.g., via cosine similarity, statistical inference algorithms, and/or the like) to determine a content similarity score between the relational report group and the service update report 122. The engine 202 can further compare the determined content similarity score with a group similarity threshold to evaluate a correlation strength between contents of member user feedback reports 124 of the relational report group and the service update report 122. In response to the content similarity score satisfying the group similarity threshold value (e.g., a range of threshold values), the engine 202 can assign, or map, the member user feedback reports 124 of the relational report group to the service update report 122. As a result, the engine 202 can further perform, or execute, one or more operations described herein with respect to an individual user feedback report 124 for each of the member user feedback reports 124 and the assigned service update report 122. In additional or alternative implementations, the engine 202 can assign an individual user feedback report 124 to a plurality of distinct relational report groups, which enables the select user feedback report 124 to be mapped to a plurality of service update reports 122.

In response to the content similarity score satisfying the select similarity threshold value (or a range of minimum and maximum threshold values) of the service update report 122, the engine 202 can be configured to identify the specific contents (e.g., text descriptions) that are similar between the user feedback report 124 and the service update report 122. For example, the engine 202 can generate, and invoke, a prompt for a generative machine learning model (e.g., a transformer, a large language model) configured to create a response comprising an identified set of shared, or similar, contents between the set of descriptors of the select service update report 122 and text contents of the user feedback report 124. In some implementations, the engine 202 can further configure the prompt to generate, within the created response, a signal (e.g., a binary variable) indicating whether similar content was found between the service update report 122 and the user feedback report 124.

The engine 202 can be configured to refine and/or adjust the determined content similarity scores between the user feedback report 124 and the service update report 122. For example, the engine 202 can access (e.g., from the reports database 204) a set of prior user feedback reports comprising a content similarity score that previously exceeded the select similarity threshold of the service update report 122. Using the contents of the prior user feedback reports, the engine 202 can estimate an adjustment to the content similarity score of the user feedback report 124 and the service update report 122. As an illustrative example, the engine 202 can generate, and invoke, a prompt for the generative machine learning model to create a response comprising an adjustment to the determined content similarity score. In particular, the engine 202 can configure the contextual information for the prompt to include the set of descriptors, the text contents of the user feedback report 124, and/or the text contents of the prior user feedback report.

In response to a positive indication of content similarity, the engine 202 can be configured to identify the similar content from the service update report 122 and the user feedback report 124. For example, the engine 202 can execute a matching algorithm (e.g., pattern recognition, similarity evaluation, and/or the like) to identify select phrases or shared contents between the identified similar content and the reports 122, 124. In another example, the engine 202 can generate, and invoke, a prompt for the generative machine learning model configured to create a response comprising the select phrases and/or shared contents from the reports 122, 124. In additional or alternative implementations, the engine 202 can use the semantic encoder function to generate an additional (e.g., second) semantic embedding vector based on the identified similar content from eh service update report 122. Accordingly, the engine 202 can iteratively perform one or more of the foregoing operations and/or process with respect to comparing contents of the user feedback report 124 and the service update report 122.

The incident detection engine 202 can be further configured to update an incidence frequency data of a runtime service associated with the service update report 122. For example, the engine 202 can access, from the reports database 204, an incidence frequency data associated with the runtime service for the service update report 122. The incidence frequency data can comprise quantitative metrics that measure an approximate severity of erroneous features associated with the runtime service. In some implementations, the incidence frequency data can comprise a frequency count of prior user reported incidents regarding the runtime service. In other implementations, the incidence frequency data can comprise a time-series sequence of individual frequency counts that each correspond to a specified timestamp.

In response to identifying significant correlational relationships (e.g., similarity relationships) between service update reports 122 and user feedback reports 124, the engine 202 can incrementally increase the frequency counts of the incidence frequency data for the runtime service. As an illustrative example, the engine 202 can increment the incidence frequency count for a select service update report 122, and associated runtime service, using a static value (e.g., +1). In other implementations, the engine 202 can increment the incidence frequency count using a dynamic value that scales based on the relative severity of user feedback reports 122 for the runtime service. For instance, the engine 202 can scale up (e.g., or scale down) the magnitude of the dynamic value in response to increased (e.g., or decreased) intake of user feedback reports 122 for the runtime, a long (e.g., or short) time duration since detection of the first user feedback report 122 for the runtime service, or a set of predefined rules (e.g., a blacklist of runtime services) that require specific magnitude values.

The incidence detection engine 202 can be further configured to send notification messages 208 to subscribed users (e.g., authorized users 112). For example, the engine 202 can transmit (e.g., to subscribed users of the incidence detection system) a notification message 208 indicating that incidence frequency data of a runtime service exceeds a tolerance threshold. In some implementations, the engine 202 can be configured to use a static tolerance threshold for evaluating the incidence frequency data of the runtime service. In other implementations, the engine 202 can be configured to use a dynamic tolerance threshold for evaluating the incidence frequency data. As an illustrative example, the engine 202 can monitor a set of incidence frequency counts and/or scores within a specified duration (e.g., a time interval) to determine a temporary baseline tolerance threshold (e.g., a rolling average). In another example, the engine 202 can apply a machine learning model 206 (e.g., statistical inference model, generative machine learning model, and/or the like) on the incidence frequency data to determine an appropriate tolerance threshold.

In some implementations, the engine 202 can configure the notification message 208 to recommend a maintenance review of the runtime service. In additional or alternative implementations, the engine 202 can configure the notification message 208 to comprise a set of recommended remediation strategies (e.g., maintenance and/or corrective actions) that the subscribing user (e.g., authorized user 112) may immediately deploy to potentially resolve erroneous features of the runtime service. For instance, the set of recommended remediation strategies can include an option to revert the runtime service to a prior (e.g., stable) service version and/or an option to submit a maintenance request for assistance from other authorized users 112 in reviewing and investigating the afflicted runtime service features. In some implementations, the engine 202 can use a generative machine learning model (e.g., a large language model, a transformer) to create the set of recommended remediation strategies. In further implementations, the engine 202 can be configured to receive a user selection (e.g., from a user interface) to perform one or more recommended remediation strategies of the displayed notification message 208. Accordingly, the engine 202 can automatically execute one or more computational processes and/or operations of the incidence detection system 100 required to perform the selected remediation strategies.

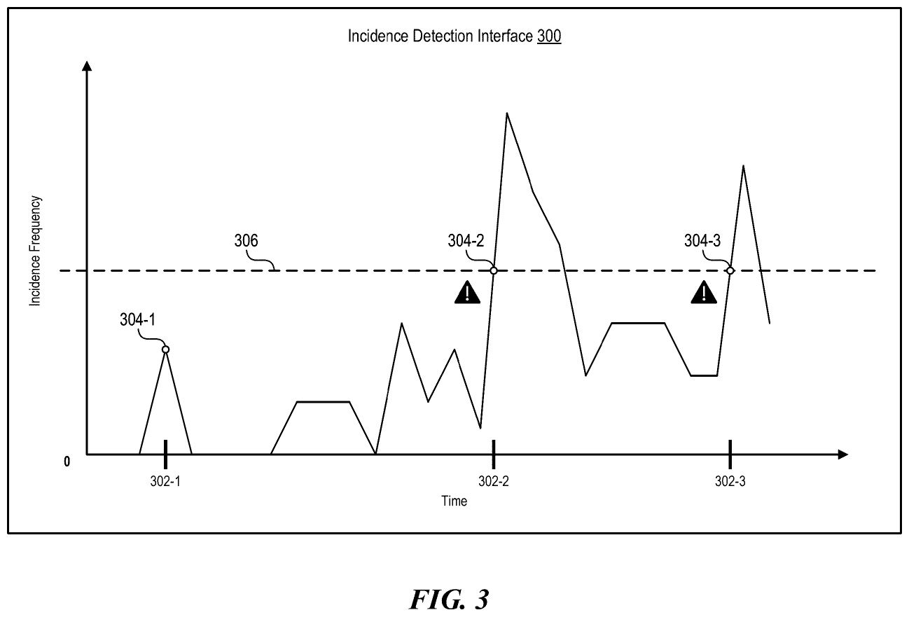

FIG. 3 is a block diagram illustrating example components of an incidence detection interface 300 of an incidence detection system, in accordance with some implementations of the present technology. The incidence detection interface 300 (“interface 300”) includes a timestamp component 302, an incidence frequency component 304, and a tolerance threshold 306. The incidence detection engine described herein is the same as, or similar to, the incidence detection engine 202 illustrated and described in more detail with reference to FIG. 2. Likewise, implementations of example components of the custom feedback interface 300 can include different and/or additional components or can be connected in different ways.

The incidence detection engine can be configured to display incidence frequency data associated with service update reports 122 of a runtime service. As shown in FIG. 3, the interface 300 can be configured to visualize a time-series representation of incidence frequency counts and/or scores for the runtime service. The interface 300 can comprise a graphical view that maps time-dependent incidence frequency counts (e.g., dependent variable) within a specified time interval (e.g., independent variable). Accordingly, the interface 300 can plot a visual trend that tracks the local incidence frequency count across individual time increments. For example, the interface 300 can plot the incidence frequency components 304-1 through 304-3 at the corresponding timestamp components 302-1 through 302-3.

The interface 300 can be configured to generate visual markings (e.g., symbols, highlights, dynamic alerts) that aid subscribing users (e.g., authorized users) of the incidence detection system in identifying anomalous incidence frequency data. As shown, the interface 300 can prominently display both the tolerance threshold 306 (e.g., dotted line) and trend plot for the incidence frequency data (e.g., solid line) using distinguishing visual markings. In another example, the interface 300 can display a notification symbol (e.g., an alert icon) within proximity of incidence frequency components 304-2, 304-3 that meet, or surpass, the tolerance threshold 306, as depicted in FIG. 3.

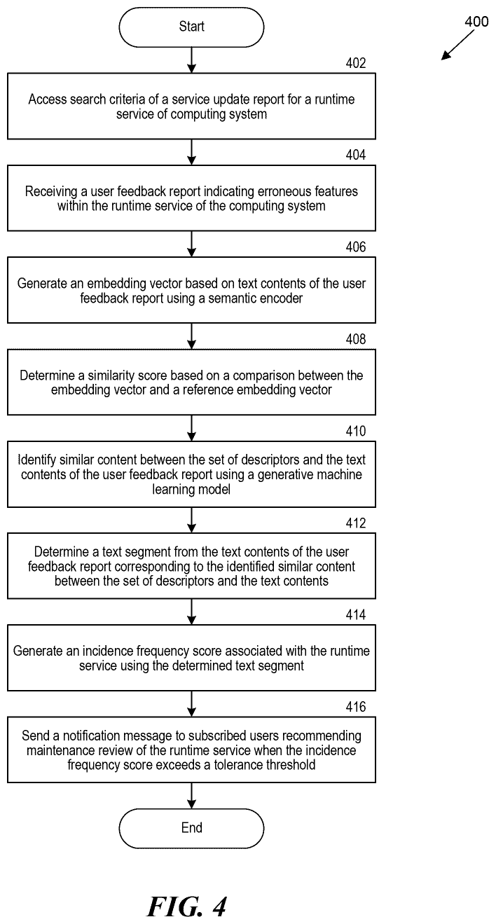

FIG. 4 is a flow diagram that illustrates a process 400 to generate service maintenance recommendations in some implementations. The process 400 can be performed by a system (e.g., incidence detection system 100) configured to detect high incidence frequencies of runtime service features based on user feedback information. In one example, the system includes at least one hardware processor and at least one non-transitory memory storing instructions, which, when executed by the at least one hardware processor, cause the system to perform the process 400. In another example, the system includes a non-transitory, computer-readable storage medium comprising instructions recorded thereon, which, when executed by at least one data processor, cause the system to perform the process 400.

At 402, the system can be configured to access search criteria of a service update report (e.g., a service change record) for a runtime service of computing system. For example, the system can access one or more search criterions that comprise a set of descriptors (e.g., text descriptions) representing adjustments to a prior version of the runtime service and/or a similarity threshold for a reference embedding vector of the set of descriptors. In some implementations, the system can access search criteria of a service update report that comprises a plurality of similarity thresholds for the reference embedding vector. As an example, the system can access one or more search criterions that comprise a first similarity threshold for a reference embedding vector of the set of descriptors and a second similarity threshold for the reference embedding vector such that the second similarity threshold imposes a stricter, or permissive, criterion than the first similarity threshold. In additional or alternative implementations, the set of descriptors of the search criteria can include a keyword, a text phrase, a service change record, a documentation submitted by an author of the service update report, or a combination thereof.

At 404, the system can be configured to receive a user feedback report (e.g., a customer complaint report) indicating erroneous features within the runtime service of the computing system. For example, the system can receive a user feedback report that comprises (e.g., at least a portion of) text contents based on a transcript of recorded audio data. In some implementations, the system can use a machine learning model (e.g., a natural language processing model, a speech-to-text model) to generate the transcript of the recorded audio data.

At 406, the system can be configured to generate an embedding vector based on text contents of the user feedback report. For example, the system can use a semantic encoder (e.g., a transformer model, encoding function) to generate an embedding vector using the text contents of the user feedback report. In some implementations, the system can be configured to generate a plurality of embedding vectors using the semantic encoder. As an example, the system can use the semantic encoder to generate a first embedding vector based on the text contents of the user feedback report and a second embedding vector based on a component text (e.g., a text segment) from the text contents of the user feedback report.

At 408, the system can be configured to determine a similarity score based on a comparison (e.g., cosine similarity, Euclidean distance, and/or the like) between the embedding vector and the reference embedding vector. In some implementations, the system can be configured to determine a similarity score for a plurality of embedding vectors with respect to the reference embedding vector. For example, the system can determine a first similarity score based on a comparison between the first embedding vector and the reference embedding vector and a second similarity score based on a comparison between a second embedding vector and the reference embedding vector.

At 410, the system can be configured to identify similar content (e.g., text descriptions) between the set of descriptors and the text contents of the user feedback report. For example, the system can prompt a generative machine learning model to create a response identifying similar content between the set of descriptors and the text contents of the user feedback report. In some implementations, the system can be configured to identify the similar content in response to the similarity score (e.g., first similarity score) exceeding the similarity threshold (e.g., first similarity threshold).

In some implementations, the system can access (e.g., from a remote database) a prior user feedback report corresponding to a similarity score that exceeds the similarity score (e.g., first similarity score) of the search criteria. Accordingly, the system can prompt the generative machine learning model to create a response comprising an adjustment to the similarity score (e.g., first similarity score) based on the set of descriptors, the text contents of the user feedback report, text contents of the prior user feedback report, or a combination thereof.

At 412, the system can be configured to determine a text segment from the text contents of the user feedback report that corresponds to the identified similar content between the set of descriptors and the text contents. In some implementations, the system can determine the text segment in response to a positive indication of content similarity from the generated response that identifies similar content between the set of descriptors and the text contents of the user feedback report.

At 414, the system can be configured to use the determined text segment to generate an incidence frequency score associated with the runtime service. In some implementations, the system can use the semantic encoder to generate a second embedding vector based on the determined text segment. The system can further determine a second similarity score based on a comparison between the second embedding vector and the reference embedding vector. In response to the second similarity score exceeding the second similarity threshold, the system can increment an incidence frequency score associated with the runtime service.

In some implementations, the system can access a time-series record of incidence frequency scores associated with the runtime service. Using the accessed time-series record, the system can identify a target incidence frequency score associated with a current timestamp (e.g., timestamp of execution). Accordingly, the system can increment the target incidence frequency score from the time-series record that is selected based on the current timestamp.

At 416, the system can be configured to send a notification message (e.g., via a user interface) to subscribed users (e.g., authorized service developers) recommending maintenance review of the runtime service. In some implementations, the system can send the notification message to the subscribed users when the incidence frequency score exceeds a tolerance threshold. In other implementations, the system can dynamically adjust the tolerance threshold based on an incidence frequency pattern. For example, the system can identify a frequency pattern within the time-series record of incidence frequency scores. Accordingly, the system can dynamically adjust the tolerance threshold based on the identified frequency pattern. In additional or alternative implementations, the system can generate a set of recommended remediation strategies for the notification message using the generative machine learning model.

### Suitable Computing Environments

FIG. 5 is a block diagram that illustrates example components incorporated in at least some of the computer systems and other devices on which the disclosed system operates. In various implementations, these computer systems and other device(s) 500 can include server computer systems, desktop computer systems, laptop computer systems, netbooks, mobile phones, personal digital assistants, televisions, cameras, automobile computers, electronic media players, web services, mobile devices, watches, wearables, glasses, smartphones, tablets, smart displays, virtual reality devices, augmented reality devices, etc. In various implementations, the computer systems and devices include zero or more of each of the following: input components 504, including keyboards, microphones, image sensors, touch screens, buttons, touch screens, track pads, mice, CD drives, DVD drives, 3.5 mm input jack, HDMI input connections, VGA input connections, USB input connections, or other computing input components; output components 506, including display screens (e.g., LCD, OLED, CRT, etc.), speakers, 3.5 mm output jack, lights, LED's, haptic motors, or other output-related components; processor(s) 508, including a central processing unit (CPU) for executing computer programs, a graphical processing unit (GPU) for executing computer graphic programs and handling computing graphical elements; storage(s) 510, including at least one computer memory for storing programs (e.g., application(s) 512, model(s) 514), and other programs) and data while they are being used, including the facility and associated data, an operating system including a kernel, and device drivers; a network connection component(s) 516 for the computer system to communicate with other computer systems and to send and/or receive data, such as via the Internet or another network and its networking hardware, such as switches, routers, repeaters, electrical cables and optical fibers, light emitters and receivers, radio transmitters and receivers, and the like; a persistent storage(s) device 518, such as a hard drive or flash drive for persistently storing programs and data; and computer-readable media drives 520 (e.g., at least one non-transitory computer-readable medium) that are tangible storage means that do not include a transitory, propagating signal, such as a floppy, CD-ROM, or DVD drive, for reading programs and data stored on a computer-readable medium. While computer systems configured as described above are typically used to support the operation of the facility, those skilled in the art will appreciate that the facility may be implemented using devices of various types and configurations, and having various components.

FIG. 6 is a system diagram illustrating an example of a computing environment in which the disclosed system operates in some implementations. In some implementations, environment 600 includes one or more client computing devices 605A-D, examples of which can host the incidence detection system 100 of FIG. 1. Client computing devices 605 operate in a networked environment using logical connections through network 630 to one or more remote computers, such as a server computing device.

In some implementations, server 610 is an edge server which receives client requests and coordinates fulfillment of those requests through other servers, such as servers 620A-C. In some implementations, server computing devices 610 and 620 comprise computing systems, such as the incidence detection system 100 of FIG. 1. Though each server computing device 610 and 620 is displayed logically as a single server, server computing devices can each be a distributed computing environment encompassing multiple computing devices located at the same or at geographically disparate physical locations. In some implementations, each server 620 corresponds to a group of servers.

Client computing devices 605 and server computing devices 610 and 620 can each act as a server or client to other server or client devices. In some implementations, servers (610, 620A-C) connect to a corresponding database (615, 625A-C). As discussed above, each server 620 can correspond to a group of servers, and each of these servers can share a database or can have its own database. Databases 615 and 625 warehouse (e.g., store) information such as claims data, email data, call transcripts, call logs, policy data and so on. Though databases 615 and 625 are displayed logically as single units, databases 615 and 625 can each be a distributed computing environment encompassing multiple computing devices, can be located within their corresponding server, or can be located at the same or at geographically disparate physical locations.

Network 630 can be a local area network (LAN) or a wide area network (WAN), but can also be other wired or wireless networks. In some implementations, network 630 is the Internet or some other public or private network. Client computing devices 605 are connected to network 630 through a network interface, such as by wired or wireless communication. While the connections between server 610 and servers 620 are shown as separate connections, these connections can be any kind of local, wide area, wired, or wireless network, including network 630 or a separate public or private network.

### Machine Learning Model(s)

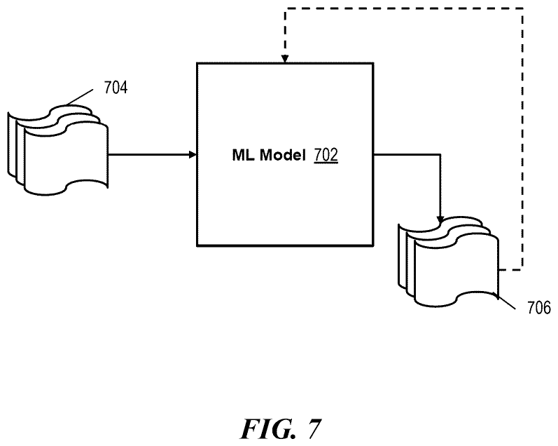

FIG. 7 is an illustrative diagram illustrating a machine learning model, in accordance with some implementations of the present technology. In some implementations, machine learning model 702 can be part of, or work in conjunction with logical component 102. For example, logical component 102 can be a computer program that can use information obtained from machine learning model 702. In other implementations, machine learning model 702 may represent logical component 102, in accordance with some implementations of the present technology.

In some implementations, the machine learning model 702 can include one or more neural networks or other machine learning models. As an example, neural networks may be based on a large collection of neural units (or artificial neurons). Neural networks may loosely mimic the manner in which a biological brain works (e.g., via large clusters of biological neurons connected by axons). Each neural unit of a neural network may be connected with many other neural units of the neural network. Such connections can be enforcing or inhibitory in their effect on the activation state of connected neural units. In some implementations, each individual neural unit may have a summation function which combines the values of all its inputs together. In some implementations, each connection (or the neural unit itself) may have a threshold function such that the signal must surpass the threshold before it propagates to other neural units. These neural network systems may be self-learning and trained, rather than explicitly programmed, and can perform significantly better in certain areas of problem solving, as compared to traditional computer programs. In some implementations, neural networks may include multiple layers (e.g., where a signal path traverses from front layers to back layers). In some implementations, back propagation techniques may be utilized by the neural networks, where forward stimulation is used to reset weights on the “front” neural units. In some implementations, stimulation and inhibition for neural networks may be more free-flowing, with connections interacting in a more chaotic and complex fashion.

As an example, with respect to FIG. 7, machine learning model 702 can take inputs 704 and provide outputs 706. In one use case, outputs 706 may be fed back to machine learning model 702 as input to train machine learning model 702 (e.g., alone or in conjunction with user indications of the accuracy of outputs 706, labels associated with the inputs, or with other reference feedback information). In another use case, machine learning model 702 may update its configurations (e.g., weights, biases, or other parameters) based on its assessment of its prediction (e.g., outputs 706) and reference feedback information (e.g., user indication of accuracy, reference labels, or other information). In another use case, where machine learning model 702 is a neural network, connection weights may be adjusted to reconcile differences between the neural network's prediction and the reference feedback. In a further use case, one or more neurons (or nodes) of the neural network may require that their respective errors are sent backward through the neural network to them to facilitate the update process (e.g., backpropagation of error). Updates to the connection weights may, for example, be reflective of the magnitude of error propagated backward after a forward pass has been completed. In this way, for example, the machine learning model 702 may be trained to generate better predictions.

As an example, where the prediction models include a neural network, the neural network may include one or more input layers, hidden layers, and output layers. The input and output layers may respectively include one or more nodes, and the hidden layers may each include a plurality of nodes. When an overall neural network includes multiple portions trained for different objectives, there may or may not be input layers or output layers between the different portions. The neural network may also include different input layers to receive various input data. Also, in differing examples, data may input to the input layer in various forms, and in various dimensional forms, input to respective nodes of the input layer of the neural network. In the neural network, nodes of layers other than the output layer are connected to nodes of a subsequent layer through links for transmitting output signals or information from the current layer to the subsequent layer, for example. The number of the links may correspond to the number of the nodes included in the subsequent layer. For example, in adjacent fully connected layers, each node of a current layer may have a respective link to each node of the subsequent layer, noting that in some examples such full connections may later be pruned or minimized during training or optimization. In a recurrent structure, a node of a layer may be again input to the same node or layer at a subsequent time, while in a bi-directional structure, forward and backward connections may be provided. The links are also referred to as connections or connection weights, referring to the hardware implemented connections or the corresponding “connection weights” provided by those connections of the neural network. During training and implementation, such connections and connection weights may be selectively implemented, removed, and varied to generate or obtain a resultant neural network that is thereby trained and that may be correspondingly implemented for the trained objective, such as for any of the above example recognition objectives.

To assist in understanding the present disclosure, some concepts relevant to neural networks and machine learning (ML) are discussed herein. Generally, a neural network comprises a number of computation units (sometimes referred to as “neurons”). Each neuron receives an input value and applies a function to the input to generate an output value. The function typically includes a parameter (also referred to as a “weight”) whose value is learned through the process of training. A plurality of neurons may be organized into a neural network layer (or simply “layer”) and there may be multiple such layers in a neural network. The output of one layer may be provided as input to a subsequent layer. Thus, input to a neural network may be processed through a succession of layers until an output of the neural network is generated by a final layer. This is a simplistic discussion of neural networks and there may be more complex neural network designs that include feedback connections, skip connections, and/or other such possible connections between neurons and/or layers, which are not discussed in detail here.

A deep neural network (DNN) is a type of neural network having multiple layers and/or a large number of neurons. The term DNN may encompass any neural network having multiple layers, including convolutional neural networks (CNNs), recurrent neural networks (RNNs), multilayer perceptrons (MLPs), Generative Adversarial Networks (GANs), Variational Autoencoders (VAEs), and Auto-regressive Models, among others.

DNNs are often used as ML-based models for modeling complex behaviors (e.g., human language, image recognition, object classification) in order to improve the accuracy of outputs (e.g., more accurate predictions) such as, for example, as compared with models with fewer layers. In the present disclosure, the term “ML-based model” or more simply “ML model” may be understood to refer to a DNN. Training an ML model refers to a process of learning the values of the parameters (or weights) of the neurons in the layers such that the ML model is able to model the target behavior to a desired degree of accuracy. Training typically requires the use of a training dataset, which is a set of data that is relevant to the target behavior of the ML model.

As an example, to train an ML model that is intended to model human language (also referred to as a language model), the training dataset may be a collection of text documents, referred to as a text corpus (or simply referred to as a corpus). The corpus may represent a language domain (e.g., a single language), a subject domain (e.g., scientific papers), and/or may encompass another domain or domains, be they larger or smaller than a single language or subject domain. For example, a relatively large, multilingual and non-subject-specific corpus may be created by extracting text from online webpages and/or publicly available social media posts. Training data may be annotated with ground truth labels (e.g., each data entry in the training dataset may be paired with a label), or may be unlabeled.

Training an ML model generally involves inputting into an ML model (e.g., an untrained ML model) training data to be processed by the ML model, processing the training data using the ML model, collecting the output generated by the ML model (e.g., based on the inputted training data), and comparing the output to a desired set of target values. If the training data is labeled, the desired target values may be, e.g., the ground truth labels of the training data. If the training data is unlabeled, the desired target value may be a reconstructed (or otherwise processed) version of the corresponding ML model input (e.g., in the case of an autoencoder), or can be a measure of some target observable effect on the environment (e.g., in the case of a reinforcement learning agent). The parameters of the ML model are updated based on a difference between the generated output value and the desired target value. For example, if the value outputted by the ML model is excessively high, the parameters may be adjusted so as to lower the output value in future training iterations. An objective function is a way to quantitatively represent how close the output value is to the target value. An objective function represents a quantity (or one or more quantities) to be optimized (e.g., minimize a loss or maximize a reward) in order to bring the output value as close to the target value as possible. The goal of training the ML model typically is to minimize a loss function or maximize a reward function.

The training data may be a subset of a larger data set. For example, a data set may be split into three mutually exclusive subsets: a training set, a validation (or cross-validation) set, and a testing set. The three subsets of data may be used sequentially during ML model training. For example, the training set may be first used to train one or more ML models, each ML model, e.g., having a particular architecture, having a particular training procedure, being describable by a set of model hyperparameters, and/or otherwise being varied from the other of the one or more ML models. The validation (or cross-validation) set may then be used as input data into the trained ML models to, e.g., measure the performance of the trained ML models and/or compare performance between them. Where hyperparameters are used, a new set of hyperparameters may be determined based on the measured performance of one or more of the trained ML models, and the first step of training (i.e., with the training set) may begin again on a different ML model described by the new set of determined hyperparameters. In this way, these steps may be repeated to produce a more performant trained ML model. Once such a trained ML model is obtained (e.g., after the hyperparameters have been adjusted to achieve a desired level of performance), a third step of collecting the output generated by the trained ML model applied to the third subset (the testing set) may begin. The output generated from the testing set may be compared with the corresponding desired target values to give a final assessment of the trained ML model's accuracy. Other segmentations of the larger data set and/or schemes for using the segments for training one or more ML models are possible.

Backpropagation is an algorithm for training an ML model. Backpropagation is used to adjust (also referred to as update) the value of the parameters in the ML model, with the goal of optimizing the objective function. For example, a defined loss function is calculated by forward propagation of an input to obtain an output of the ML model and a comparison of the output value with the target value. Backpropagation calculates a gradient of the loss function with respect to the parameters of the ML model, and a gradient algorithm (e.g., gradient descent) is used to update (i.e., “learn”) the parameters to reduce the loss function. Backpropagation is performed iteratively so that the loss function is converged or minimized. Other techniques for learning the parameters of the ML model may be used. The process of updating (or learning) the parameters over many iterations is referred to as training. Training may be carried out iteratively until a convergence condition is met (e.g., a predefined maximum number of iterations has been performed, or the value outputted by the ML model is sufficiently converged with the desired target value), after which the ML model is considered to be sufficiently trained. The values of the learned parameters may then be fixed and the ML model may be deployed to generate output in real-world applications (also referred to as “inference”).

In some examples, a trained ML model may be fine-tuned, meaning that the values of the learned parameters may be adjusted slightly in order for the ML model to better model a specific task. Fine-tuning of an ML model typically involves further training the ML model on a number of data samples (which may be smaller in number/cardinality than those used to train the model initially) that closely target the specific task. For example, an ML model for generating natural language that has been trained generically on publically-available text corpora may be, e.g., fine-tuned by further training using specific training samples. The specific training samples can be used to generate language in a certain style or in a certain format. For example, the ML model can be trained to generate a blog post having a particular style and structure with a given topic.

Some concepts in ML-based language models are now discussed. It may be noted that, while the term “language model” has been commonly used to refer to a ML-based language model, there could exist non-ML language models. In the present disclosure, the term “language model” may be used as shorthand for an ML-based language model (i.e., a language model that is implemented using a neural network or other ML architecture), unless stated otherwise. For example, unless stated otherwise, the “language model” encompasses LLMs.

A language model may use a neural network (typically a DNN) to perform natural language processing (NLP) tasks. A language model may be trained to model how words relate to each other in a textual sequence, based on probabilities. A language model may contain hundreds of thousands of learned parameters or in the case of a large language model (LLM) may contain millions or billions of learned parameters or more. As non-limiting examples, a language model can generate text, translate text, summarize text, answer questions, write code (e.g., Phyton, JavaScript, or other programming languages), classify text (e.g., to identify spam emails), create content for various purposes (e.g., social media content, factual content, or marketing content), or create personalized content for a particular individual or group of individuals. Language models can also be used for chatbots (e.g., virtual assistance).

In recent years, there has been interest in a type of neural network architecture, referred to as a transformer, for use as language models. For example, the Bidirectional Encoder Representations from Transformers (BERT) model, the Transformer-XL model, and the Generative Pre-trained Transformer (GPT) models are types of transformers. A transformer is a type of neural network architecture that uses self-attention mechanisms in order to generate predicted output based on input data that has some sequential meaning (i.e., the order of the input data is meaningful, which is the case for most text input). Although transformer-based language models are described herein, it should be understood that the present disclosure may be applicable to any ML-based language model, including language models based on other neural network architectures such as recurrent neural network (RNN)-based language models.

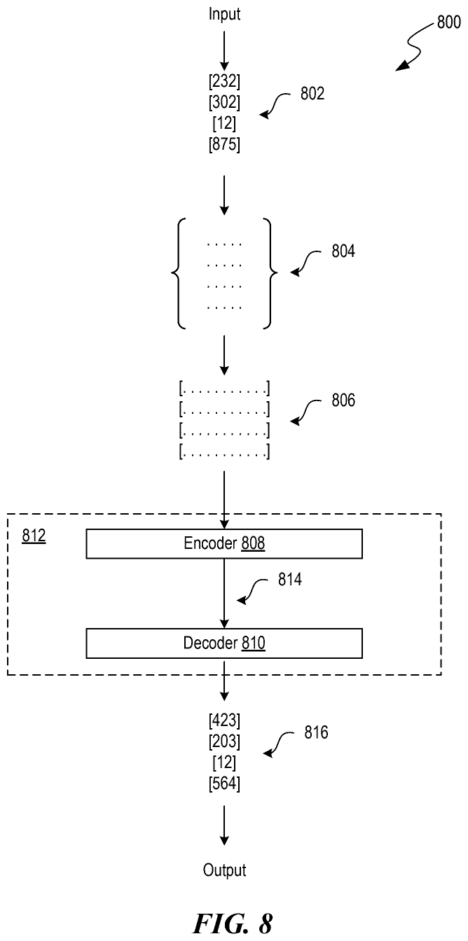

FIG. 8 is a block diagram of an example transformer 812 that can implement aspects of the present technology. A transformer is a type of neural network architecture that uses self-attention mechanisms to generate predicted output based on input data that has some sequential meaning (i.e., the order of the input data is meaningful, which is the case for most text input). Self-attention is a mechanism that relates different positions of a single sequence to compute a representation of the same sequence. Although transformer-based language models are described herein, it should be understood that the present disclosure may be applicable to any machine learning (ML)-based language model, including language models based on other neural network architectures such as recurrent neural network (RNN)-based language models.

The transformer 812 includes an encoder 808 (which can comprise one or more encoder layers/blocks connected in series) and a decoder 810 (which can comprise one or more decoder layers/blocks connected in series). Generally, the encoder 808 and the decoder 810 each include a plurality of neural network layers, at least one of which can be a self-attention layer. The parameters of the neural network layers can be referred to as the parameters of the language model.

The transformer 812 can be trained to perform certain functions on a natural language input. For example, the functions include summarizing existing content, brainstorming ideas, writing a rough draft, fixing spelling and grammar, and translating content. Summarizing can include extracting key points from an existing content in a high-level summary. Brainstorming ideas can include generating a list of ideas based on provided input. For example, the ML model can generate a list of names for a startup or costumes for an upcoming party. Writing a rough draft can include generating writing in a particular style that could be useful as a starting point for the user's writing. The style can be identified as, e.g., an email, a blog post, a social media post, or a poem. Fixing spelling and grammar can include correcting errors in an existing input text. Translating can include converting an existing input text into a variety of different languages. In some embodiments, the transformer 812 is trained to perform certain functions on other input formats than natural language input. For example, the input can include objects, images, audio content, or video content, or a combination thereof.

The transformer 812 can be trained on a text corpus that is labeled (e.g., annotated to indicate verbs, nouns) or unlabeled. Large language models (LLMs) can be trained on a large unlabeled corpus. The term “language model,” as used herein, can include an ML-based language model (e.g., a language model that is implemented using a neural network or other ML architecture), unless stated otherwise. Some LLMs can be trained on a large multi-language, multi-domain corpus to enable the model to be versatile at a variety of language-based tasks such as generative tasks (e.g., generating human-like natural language responses to natural language input). FIG. 8 illustrates an example process 800 of how the transformer 812 can process textual input data. Input to a language model (whether transformer-based or otherwise) typically is in the form of natural language that can be parsed into tokens. It should be appreciated that the term “token” in the context of language models and Natural Language Processing (NLP) has a different meaning from the use of the same term in other contexts such as data security. Tokenization, in the context of language models and NLP, refers to the process of parsing textual input (e.g., a character, a word, a phrase, a sentence, a paragraph) into a sequence of shorter segments that are converted to numerical representations referred to as tokens (or “compute tokens”). Typically, a token can be an integer that corresponds to the index of a text segment (e.g., a word) in a vocabulary dataset. Often, the vocabulary dataset is arranged by frequency of use. Commonly occurring text, such as punctuation, can have a lower vocabulary index in the dataset and thus be represented by a token having a smaller integer value than less commonly occurring text. Tokens frequently correspond to words, with or without white space appended. In some examples, a token can correspond to a portion of a word.

For example, the word “greater” can be represented by a token for [great] and a second token for [er]. In another example, the text sequence “write a summary” can be parsed into the segments [write], [a], and [summary], each of which can be represented by a respective numerical token. In addition to tokens that are parsed from the textual sequence (e.g., tokens that correspond to words and punctuation), there can also be special tokens to encode non-textual information. For example, a [CLASS] token can be a special token that corresponds to a classification of the textual sequence (e.g., can classify the textual sequence as a list, a paragraph), an [EOT] token can be another special token that indicates the end of the textual sequence, other tokens can provide formatting information, etc.

In FIG. 8, a short sequence of tokens 802 corresponding to the input text is illustrated as input to the transformer 812. Tokenization of the text sequence into the tokens 802 can be performed by some pre-processing tokenization module such as, for example, a byte-pair encoding tokenizer (the “pre” referring to the tokenization occurring prior to the processing of the tokenized input by the LLM), which is not shown in FIG. 8 for simplicity. In general, the token sequence that is inputted to the transformer 812 can be of any length up to a maximum length defined based on the dimensions of the transformer 812. Each token 802 in the token sequence is converted into an embedding vector 806 (also referred to simply as an embedding 806). An embedding 806 is a learned numerical representation (such as, for example, a vector) of a token that captures some semantic meaning of the text segment represented by the token 802. The embedding 806 represents the text segment corresponding to the token 802 in a way such that embeddings corresponding to semantically related text are closer to each other in a vector space than embeddings corresponding to semantically unrelated text. For example, assuming that the words “write,” “a,” and “summary” each correspond to, respectively, a “write” token, an “a” token, and a “summary” token when tokenized, the embedding 806 corresponding to the “write” token will be closer to another embedding corresponding to the “jot down” token in the vector space as compared to the distance between the embedding 806 corresponding to the “write” token and another embedding corresponding to the “summary”token.

The vector space can be defined by the dimensions and values of the embedding vectors. Various techniques can be used to convert a token 802 to an embedding 806. For example, another trained ML model can be used to convert the token 802 into an embedding 806. In particular, another trained ML model can be used to convert the token 802 into an embedding 806 in a way that encodes additional information into the embedding 806 (e.g., a trained ML model can encode positional information about the position of the token 802 in the text sequence into the embedding 806). In some examples, the numerical value of the token 802 can be used to look up the corresponding embedding in an embedding matrix 804 (which can be learned during training of the transformer 812).

The generated embeddings 806 are input into the encoder 808. The encoder 808 serves to encode the embeddings 806 into feature vectors 814 that represent the latent features of the embeddings 806. The encoder 808 can encode positional information (i.e., information about the sequence of the input) in the feature vectors 814. The feature vectors 814 can have very high dimensionality (e.g., on the order of thousands or tens of thousands), with each element in a feature vector 814 corresponding to a respective feature. The numerical weight of each element in a feature vector 814 represents the importance of the corresponding feature. The space of all possible feature vectors 814 that can be generated by the encoder 808 can be referred to as the latent space or feature space.

Conceptually, the decoder 810 is designed to map the features represented by the feature vectors 814 into meaningful output, which can depend on the task that was assigned to the transformer 812. For example, if the transformer 812 is used for a translation task, the decoder 810 can map the feature vectors 814 into text output in a target language different from the language of the original tokens 802. Generally, in a generative language model, the decoder 810 serves to decode the feature vectors 814 into a sequence of tokens. The decoder 810 can generate output tokens 816 one by one. Each output token 816 can be fed back as input to the decoder 810 in order to generate the next output token 816. By feeding back the generated output and applying self-attention, the decoder 810 is able to generate a sequence of output tokens 816 that has sequential meaning (e.g., the resulting output text sequence is understandable as a sentence and obeys grammatical rules). The decoder 810 can generate output tokens 816 until a special [EOT] token (indicating the end of the text) is generated. The resulting sequence of output tokens 816 can then be converted to a text sequence in post-processing. For example, each output token 816 can be an integer number that corresponds to a vocabulary index. By looking up the text segment using the vocabulary index, the text segment corresponding to each output token 816 can be retrieved, the text segments can be concatenated together, and the final output text sequence can be obtained.

In some examples, the input provided to the transformer 812 includes instructions to perform a function on an existing text. In some examples, the input provided to the transformer includes instructions to perform a function on an existing text. The output can include, for example, a modified version of the input text and instructions to modify the text. The modification can include summarizing, translating, correcting grammar or spelling, changing the style of the input text, lengthening or shortening the text, or changing the format of the text. For example, the input can include the question “What is the weather like in Australia?”and the output can include a description of the weather in Australia.

Although a general transformer architecture for a language model and its theory of operation have been described above, this is not intended to be limiting. Existing language models include language models that are based only on the encoder of the transformer or only on the decoder of the transformer. An encoder-only language model encodes the input text sequence into feature vectors that can then be further processed by a task-specific layer (e.g., a classification layer). BERT is an example of a language model that can be considered to be an encoder-only language model. A decoder-only language model accepts embeddings as input and can use auto-regression to generate an output text sequence. Transformer-XL and GPT-type models can be language models that are considered to be decoder-only language models.

Because GPT-type language models tend to have a large number of parameters, these language models can be considered LLMs. An example of a GPT-type LLM is GPT-3. GPT-3 is a type of GPT language model that has been trained (in an unsupervised manner) on a large corpus derived from documents available to the public online. GPT-3 has a very large number of learned parameters (on the order of hundreds of billions), is able to accept a large number of tokens as input (e.g., up to 2,048 input tokens), and is able to generate a large number of tokens as output (e.g., up to 2,048 tokens). GPT-3 has been trained as a generative model, meaning that it can process input text sequences to predictively generate a meaningful output text sequence. ChatGPT is built on top of a GPT-type LLM and has been fine-tuned with training datasets based on text-based chats (e.g., chatbot conversations). ChatGPT is designed for processing natural language, receiving chat-like inputs, and generating chat-like outputs.

A computer system can access a remote language model (e.g., a cloud-based language model), such as ChatGPT or GPT-3, via a software interface (e.g., an API). Additionally or alternatively, such a remote language model can be accessed via a network such as, for example, the Internet. In some implementations, such as, for example, potentially in the case of a cloud-based language model, a remote language model can be hosted by a computer system that can include a plurality of cooperating (e.g., cooperating via a network) computer systems that can be in, for example, a distributed arrangement. Notably, a remote language model can employ a plurality of processors (e.g., hardware processors such as, for example, processors of cooperating computer systems). Indeed, processing of inputs by an LLM can be computationally expensive/can involve a large number of operations (e.g., many instructions can be executed/large data structures can be accessed from memory), and providing output in a required timeframe (e.g., real time or near real time) can require the use of a plurality of processors/cooperating computing devices as discussed above.

Inputs to an LLM can be referred to as a prompt, which is a natural language input that includes instructions to the LLM to generate a desired output. A computer system can generate a prompt that is provided as input to the LLM via its API. As described above, the prompt can optionally be processed or pre-processed into a token sequence prior to being provided as input to the LLM via its API. A prompt can include one or more examples of the desired output, which provides the LLM with additional information to enable the LLM to generate output according to the desired output. Additionally or alternatively, the examples included in a prompt can provide inputs (e.g., example inputs) corresponding to/as can be expected to result in the desired outputs provided. A one-shot prompt refers to a prompt that includes one example, and a few-shot prompt refers to a prompt that includes multiple examples. A prompt that includes no examples can be referred to as a zero-shot prompt.

### Computer System

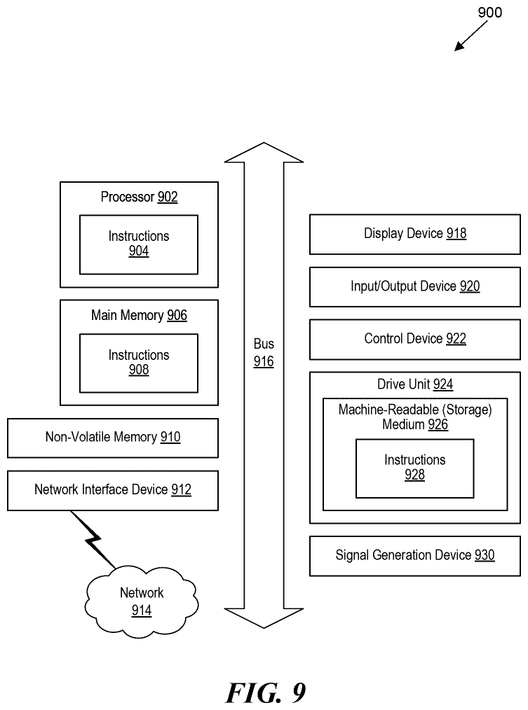

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense-that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A computer-implemented method for early detection of erroneous features of runtime services introduced by system updates, the method comprising:
accessing a service update report for a runtime service of a computing system, the service update report comprising:
(1) a set of descriptors representing recorded updates to a set of service features from a prior version of the runtime service to a new version of the runtime service and a corresponding reference embedding vector for the set of descriptors based on a first set of input tokens representing semantic elements of the service update report, wherein the reference embedding vector is pre-encoded via one or more semantic encoders and stored at a persistent memory that tracks pre-encoded reference embedding vectors of service update descriptors,
(2) a first similarity threshold for comparing the reference embedding vector of the set of descriptors to embedding vectors for received user feedback reports, and
(3) a second similarity threshold comparing for the reference embedding vector of the set of descriptors to embedding vectors for subsets of text contents of received user feedback reports, the second similarity threshold imposing a stricter criterion than the first similarity threshold;
generating a second set of input tokens representing one or more semantic elements of user feedback report that is retrieved from a user of the runtime service, the one or more semantic elements indicating erroneous features within the runtime service of the computing system;
inputting the second set of input tokens into a semantic encoder of a first artificial intelligence (AI) model to generate a first embedding vector for the user feedback report;
determining a first similarity score by comparing the first embedding vector for the second set of input tokens of the user feedback report and the reference embedding vector for the first set of input tokens of the service update report;
responsive to the first similarity score satisfying the first similarity threshold, inputting the first set of input tokens and the second set of input tokens into a second AI model to selectively extract, from the second set of input tokens of the user feedback report, a subset of input tokens with strong correlation to the first set of input tokens of the service update report, the subset of input tokens indicating similar semantic elements between the user feedback report and the service update report
wherein the second AI model is caused to be iteratively trained on sample input tokens extracted from incoming user feedback reports and stored descriptors of prior service update reports of the runtime service to predict subsets of input tokens of the incoming user feedback reports comprising semantic similarities with input tokens of the prior service update reports by prioritizing selection of input tokens of the incoming user feedback reports that indicate strong correlational relationships with the input tokens of the prior service update reports;
inputting the subset of input tokens of the user feedback report into the semantic encoder of the first AI model to generate a second embedding vector for the user feedback report;
determining a second similarity score by comparing the second embedding vector for the subset of input tokens of the user feedback report and the reference embedding vector for the first set of input tokens of the service update report;
responsive to the second similarity score satisfying the second similarity threshold, incrementing an incidence frequency score associated with the runtime service; and
when the incidence frequency score exceeds a tolerance threshold:
sending a notification message to subscribed users indicating required maintenance review of the runtime service; and
automatically deploying, at the computing system, the prior version of the runtime service to revert the set of service features of the runtime service to a stable version.

2. The method of claim 1, further comprising:
accessing, from a remote database, a prior user feedback report corresponding to a similarity score exceeding the first similarity threshold of the service update report; and
causing a generative AI model to create a response comprising an adjustment to the first similarity score based on the set of descriptors, the text contents of the user feedback report, and text contents of the prior user feedback report.

3. The method of claim 1, wherein the set of descriptors of the service update report includes a keyword, a text phrase, a service change record, a documentation submitted by an author of the service update report, or a combination thereof.

4. The method of claim 1, wherein at least a portion of the text contents of the user feedback report is based on a transcript of recorded audio data generated using a machine learning model.

5. The method of claim 1, wherein incrementing the incidence frequency score further comprises:
accessing a time-series record of incidence frequency scores associated with the runtime service; and
incrementing a target incidence frequency score from the time-series record, wherein the target incidence frequency score is selected based on a current timestamp.

6. The method of claim 5, further comprising:
identifying a frequency pattern within the time-series record of incidence frequency scores; and
dynamically adjusting the tolerance threshold based on the identified frequency pattern.

7. The method of claim 1, further comprising:
causing a generative AI model to generate a set of recommended remediation strategies for the notification message.

8. A system for early detection of erroneous features of runtime services introduced by service updates, the system comprising:
at least one hardware processor; and
at least one non-transitory memory storing instructions, which, when executed by the at least one hardware processor, cause the system to:
access a service update report for a runtime service of a computing system, the service update report comprising:
(1) a set of descriptors representing recorded updates to a set of service features from a prior version of the runtime service to a new version of the runtime service and a corresponding reference embedding vector for the set of descriptors based on a first set of input tokens representing semantic elements of the service update report, wherein the reference embedding vector is pre-encoded via one or more semantic encoders and stored at a persistent memory that tracks pre-encoded reference embedding vectors of service update descriptors,
(2) a first similarity threshold for comparing the reference embedding vector of the set of descriptors to embedding vectors for received user feedback reports, and
(3) a second similarity threshold comparing for the reference embedding vector of the set of descriptors to embedding vectors for subsets of text contents of received user feedback reports, the second similarity threshold imposing a stricter criterion than the first similarity threshold;
receive, from a user of the runtime service, a user feedback report comprising a set of descriptive characteristics indicating erroneous features within the runtime service of the computing system;
input the set of descriptive characteristics into a first generative machine learning model to generate a first embedding vector for the user feedback report;
determine a first similarity score by comparing the first embedding vector for the user feedback report and the reference embedding vector for the set of descriptors of the service update report;
responsive to the first similarity score satisfying the first similarity threshold, input the set of descriptive characteristics into a second generative machine learning model to extract a subset of descriptive characteristics from the set of descriptive characteristics of the user feedback report, the subset of descriptive characteristics corresponding to similar text contents within the set of descriptors;
input the subset of descriptive characteristics into the first generative machine learning model to generate a second embedding vector for the user feedback report;
determine a second similarity score by comparing the second embedding vector for the user feedback report and the reference embedding vector for the set of descriptors of the service update report;
responsive to the second similarity score exceeding the second similarity threshold, increment an incidence frequency score associated with the runtime service; and
when the incidence frequency score satisfies a tolerance threshold:
send a notification message to subscribed users indicating required maintenance review of the runtime service; and
automatically deploy, at the computing system, the prior version of the runtime service to revert the set of service features of the runtime service to a stable version.

9. (canceled)

10. The system of claim 8 further caused to:
access, from a remote database, a prior user feedback report corresponding to a prior similarity score exceeding the similarity threshold of the service update report; and
prompt the generative machine learning model to create a response comprising an adjustment to the similarity score based on the set of descriptors, the text contents of the user feedback report, and text contents of the prior user feedback report.

11. The system of claim 8, wherein the set of descriptors of the service update report includes a keyword, a text phrase, a service change record, a documentation submitted by an author of the service update report, or a combination thereof.

12. The system of claim 8, wherein at least a portion of the text contents of the user feedback report is based on a transcript of recorded audio data generated using a machine learning model.

13. The system of claim 8 further caused to:
access a time-series record of incidence frequency scores associated with the runtime service; and
increment a target incidence frequency score from the time-series record, wherein the target incidence frequency score is selected based on a current timestamp.

14. The system of claim 13 further caused to:
identify a frequency pattern within the time-series record of incidence frequency scores; and
dynamically adjust the tolerance threshold based on the identified frequency pattern.

15. The system of claim 8 further caused to:
generating, via the generative machine learning model, a set of recommended remediation strategies for the notification message.

16. A non-transitory, computer-readable storage medium comprising instructions recorded thereon, wherein the instructions when executed by at least one data processor of a system, cause the system to:
access a service update report comprising:
(1) a set of descriptors indicating recorded updates to a set of service features from a prior version of a runtime service of a computing service to a new version of the runtime service and a corresponding reference embedding vector for the set of descriptors based on a first set of input tokens representing semantic elements of the service update report, wherein the reference embedding vector is pre-encoded via one or more semantic encoders and stored at a persistent memory that tracks pre-encoded reference embedding vectors of service update descriptors,
(2) a first similarity threshold for comparing the reference embedding vector for the set of descriptors to embedding vectors for received user feedback reports, and
(3) a second similarity threshold comparing for the reference embedding vector of the set of descriptors to embedding vectors for subsets of text contents of received user feedback reports, the second similarity threshold imposing a stricter criterion than the first similarity threshold;
receive, via an interactive user device of an end user associated with the runtime service, a user feedback report comprising (i) a set of descriptive characteristics indicating presence of erroneous features of the runtime service at the user device and (ii) a set of interactive user actions recorded, at the user device, during usage of the runtime service by the end user, the recorded set of interactive user actions indicating one or more detected behavioral characteristics of the end user at the presence of the erroneous features of the runtime service;
generate, using the set of descriptors of the service update report and the set of interactive user actions of the user feedback report, a mapping that correlates the one or more detected behavioral characteristics of the end user to one or more reference service features of the runtime service;
input the set of descriptive characteristics of the user feedback report and the generated mapping into a first generative machine learning model to generate a first embedding vector for the user feedback report;
determine a first similarity score by comparing the first embedding vector for the user feedback report and the reference embedding vector for the set of descriptors of the service update report;
responsive to the first similarity score satisfying the first similarity threshold, input the set of descriptive characteristics into a second generative machine learning model to extract a subset of descriptive characteristics from the set of descriptive characteristics of the user feedback report, the subset of descriptive characteristics corresponding to similar text contents within the set of descriptors;
input the subset of descriptive characteristics into the first generative machine learning model to generate a second embedding vector for the user feedback report;
determine a second similarity score by comparing the second embedding vector for the user feedback report and the reference embedding vector for the set of descriptors of the service update report;
responsive to the second similarity score exceeding the second similarity threshold, increment an incidence frequency score associated with the runtime service; and
when the incidence frequency score satisfies a tolerance threshold:
send a notification message to subscribed users indicating required maintenance review of the runtime service; and
automatically deploy, at the computing system, the prior version of the runtime service to revert the set of service features of the runtime service to a stable version.

17. (canceled)

18. The non-transitory, computer-readable storage medium of claim 16, wherein the instructions further cause the system to:
access, from a remote database, a prior user feedback report corresponding to a similarity score exceeding the similarity threshold; and
prompt the generative machine learning model to create a response comprising an adjustment to the similarity score based on the set of descriptors, the text contents of the user feedback report, and text contents of the prior user feedback report.

19. The non-transitory, computer-readable storage medium of claim 16, wherein the instructions further cause the system to:
access a time-series record of incidence frequency scores associated with the runtime service; and
increment a target incidence frequency score from the time-series record, wherein the target incidence frequency score is selected based on a current timestamp.

20. The non-transitory, computer-readable storage medium of claim 19, wherein the instructions further cause the system to:
identify a frequency pattern within the time-series record of incidence frequency scores; and
dynamically adjust the tolerance threshold based on the identified frequency pattern.

21. The non-transitory, computer-readable storage medium of claim 16, wherein at least a portion of the text contents of the user feedback report is based on a transcript of recorded audio data generated using a machine learning model.

22. The non-transitory, computer-readable storage medium of claim 16, wherein the instructions further cause the system to:
generating, via the generative machine learning model, a set of recommended remediation strategies for the notification message.
